(19) United States
(12) Patent Application Publication
(10) Pub. No.: US 2026/0106927 A1
(43) Pub. Date: Apr. 16, 2026

(54) MODULAR COVER FOR ELECTRONIC DEVICES

(71) Applicant: SEARCODE S.R.L., Catanzaro (IT)

(72) Inventor: Rizieri MELE, Catanzaro (IT)

(73) Assignee: SEARCODE S.R.L., Catanzaro, CZ (IT)

(21) Appl. No.: 19/114,526

(22) PCT Filed: Oct. 4, 2023
(86) PCT No.: PCT/IB2023/059947

§ 371 Date: Mar. 24, 2025

(30) Foreign Application Priority Data
Oct. 6, 2022 (IT) 102022000020619

(51) Int. Cl. H04M 1/72409

(52) U.S. Cl. CPC H04M 1/724092

(57) ABSTRACT

A modular cover for electronic devices includes a covering and protecting element having an external rear surface, removably housing an electronic device; and a system for adjusting the dimensions of said covering and protecting element. At least one functional module includes an electronic processing unit, removably mounted on the external rear surface of the covering and protecting element. The system for adjusting the dimensions of the covering and protecting element includes a plurality of sliding arms and a plurality of interchangeable peripheral edges, where each interchangeable peripheral edge is removably connected to one end of a corresponding sliding arm.

The present invention relates to a modular cover for electronic devices.

In detail, the present invention relates to a modular cover for fixed or portable electronic devices, comprising interchangeable components able to customize aesthetic and functional characteristics of the aforementioned devices and, in particular, of smartphones and tablets.

The reference technical field, accordingly, is that of consumer electronics.

A protective element of the body of an electronic device, made in the form of a dedicated coating, in all respects plays the additional role of a means of individual expression and a follower of new trends.

Several covers, specifically designed for electronic devices, customized and with advanced functions, can are currently described in the patent literature.

A first example of a known technical solution is described by the text of the Italian patent 102019000004865, whose subject is an electronic cover for communication devices comprising a support body with an internal surface having a seat for housing a communication device and an external surface housing a microprocessor or microcontroller, equipped with a management program and a memory unit for storing digital contents. The cover comprises also a display, which covers at least partially the aforementioned external surface, suitable for reproducing digital contents. Furthermore, the microprocessor or microcontroller includes a bus connecting the display and is connected to a wireless connection module to interact with the electronic device through the management program.

A further known technical solution is described by the patent application U.S. Pat. No. 8,825,124B1, which cites a protective smart-case with multimedia capabilities through a capacitive touch screen display, a high-capacity neodymium speaker and a laser pointer integrated into the same smart-case. Such a case is designed to actively display images and videos saved to a memory of the same case, or in an external memory via a USB connection and/or to receive images from a smartphone, enclosed for example in the same smart-case.

Furthermore, the patent application U.S. Pat. No. 9,654,605B2 mentions an accessory with electrical parts for use with a portable electronic device, having a protective cover for the same portable electronic device. The accessory includes a body, a connector and electrical circuits. the body comprises a back part and a bottom part, with the former able to be slidingly attached to the back of the protective cover to removably attach the accessory to the back of the protective cover. The bottom is close to the bottom of the protective cover when the accessory is removably attached to the protective cover. The electrical connector is attached to the bottom of the accessory body and is positioned to electrically interconnect to a portable electronic device interface when the accessory is attached to the protective cover and the portable electronic device is positioned therein.

Finally, the Patent Application US2017205854A1 describes a system for displaying or projecting digital content selected by a user, comprising a cover of a mobile device, able to be removably applied on said mobile device, and a curvilinear display integrated in the cover and capable of displaying or projecting the aforementioned contents.

However, the known systems /overs for protecting electronic devices, having advanced functions of the type highlighted, suffer from some limitations, such as not combining universality, to be considered as adaptability to different models of devices, modularity and use of functions accessible via specific technological components.

The purpose of the present invention is to provide a modular cover for electronic devices that combines universality, modularity and advanced functionalities, having, therefore, characteristics such as to overcome the limits that still affect the known technical solutions.

According to the present invention, a modular cover for electronic devices is provided, as defined in the claim 1.

For a better understanding of the present invention, a preferred embodiment is now described, purely by way of non-limiting example, with reference to the attached drawings, in which:

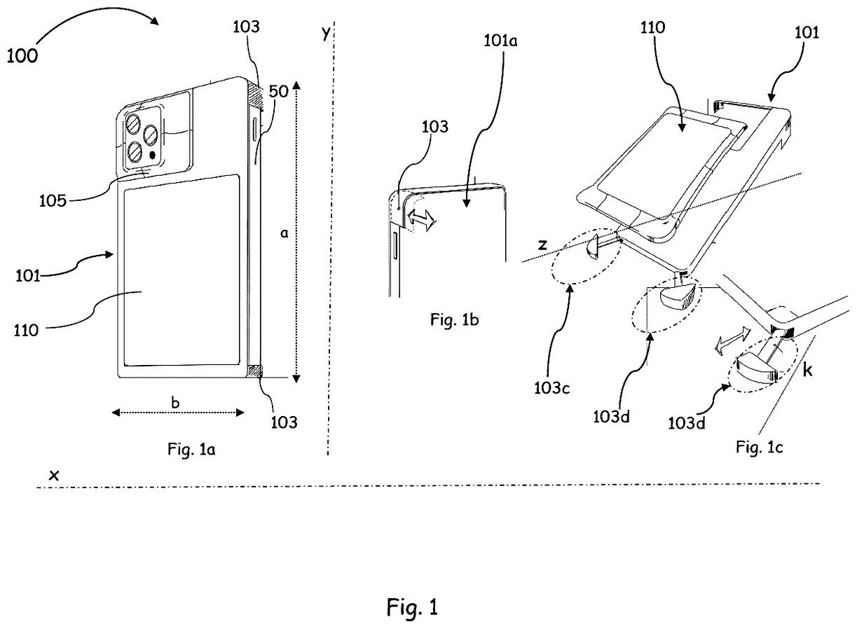

FIGS. 1a, 1b and 1c show, respectively, an overall perspective view and detail views of a first embodiment of a modular cover for electronic devices, according to the invention;

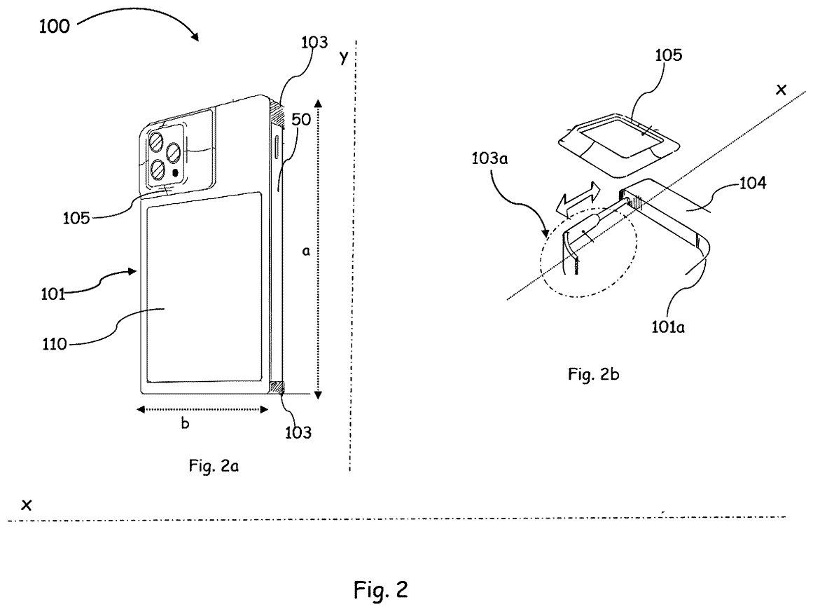

FIGS. 2a and 2b show, respectively, further overall and detail perspective views of the first embodiment of the modular cover for electronic devices, according to the invention;

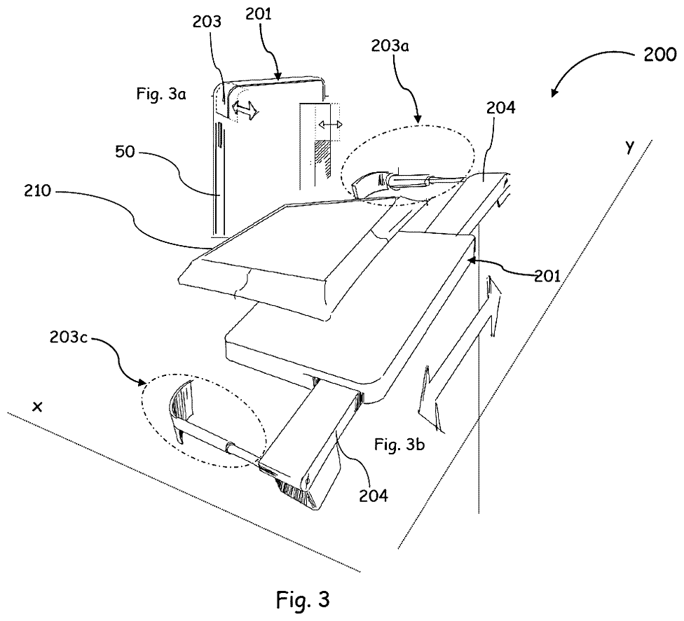

FIGS. 3a and 3b show, respectively, a perspective view of a detail and an exploded view of a second embodiment of the modular cover for electronic devices, according to the invention;

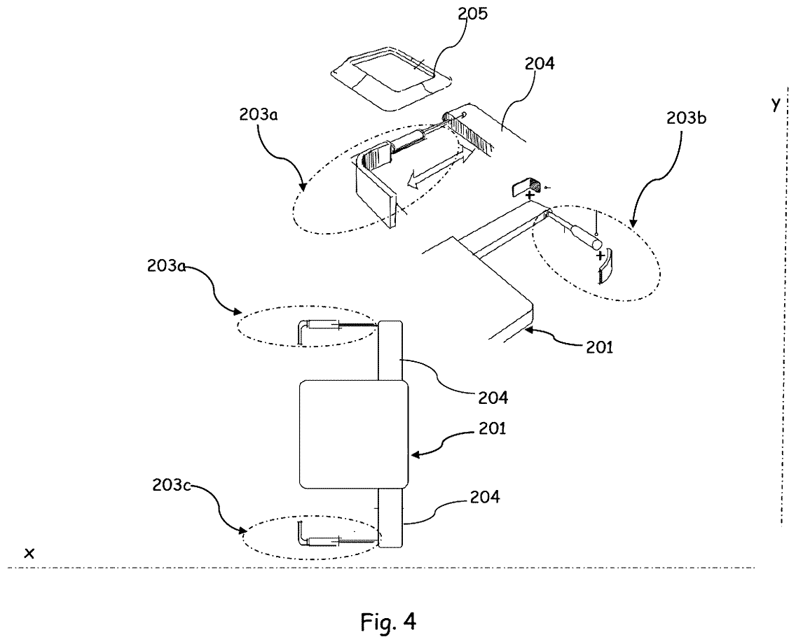

FIG. 4 shows further detail views of the second embodiment of the modular cover for electronic devices, according to the invention;

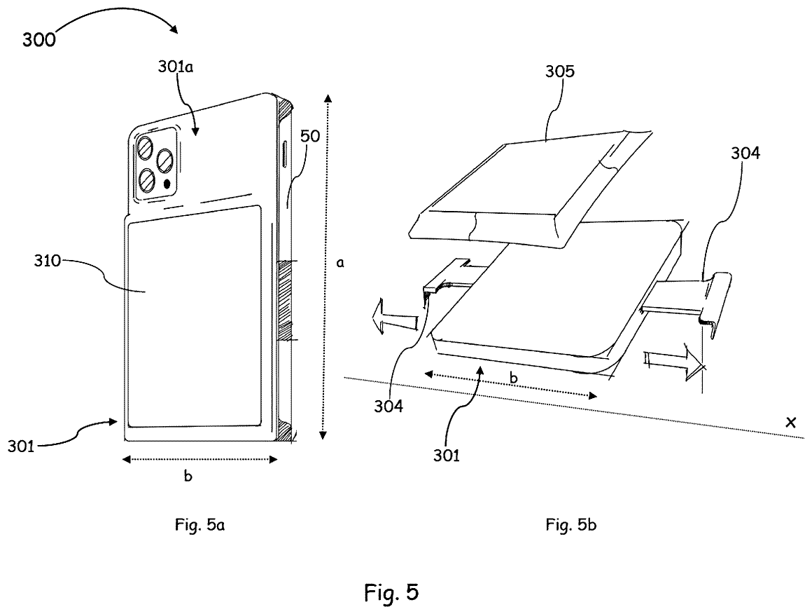

FIGS. 5a and 5b show, respectively, an overall perspective view and an exploded view of a third embodiment of the modular cover for electronic devices, according to the invention;

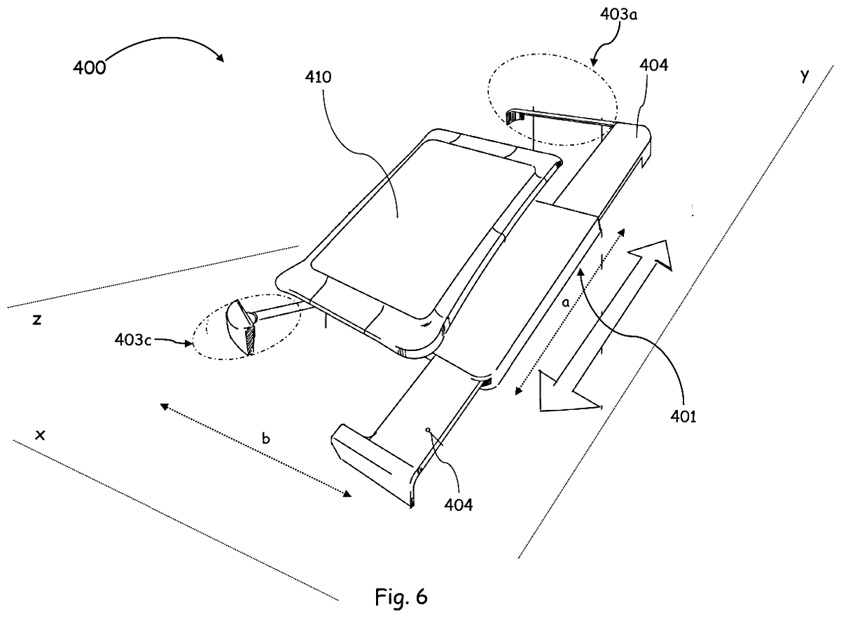

FIG. 6, eventually, shows a perspective view of a detail of a fourth embodiment of the modular cover for electronic devices, according to the invention.

With reference to these figures and, in particular, to FIG. 1, a modular cover for electronic devices is shown, according to the invention.

In particular, the modular cover 100, 200, 300, 400 for electronic devices 50 comprises:
a covering and protecting element 101, 201, 301, 401 having an external rear surface 101a, 201a, 301a, 401a removably housing an electronic device 50, for example a smartphone, a tablet, a notebook or the case of a desktop PC;
a system for adjusting the dimensions of said covering and protecting element 101, 201, 301, 401, the latter referable also as a skeleton.

According aspect of the invention, the aforementioned system for adjusting the dimensions of the covering element 101, 201, 301, 401 comprises a plurality of sliding arms and a plurality of interchangeable peripheral edges.

According to another aspect of the invention, each interchangeable peripheral edge is removably connected to one end of a corresponding sliding arm.

According to one aspect of the invention, the modular cover 100, 200, 300, 400 comprises also at least one functional module.

According to one aspect of the invention, the at least one functional module comprises an electronic processing unit.

According to another aspect of the invention, the at least one functional module is removably mounted on the rear surface 101a, 201a, 301a, 401a of the covering and protecting element 101, 201, 301, 401.

According to one aspect of the invention, the covering and protecting element 101, 201, 301, 401 has a substantially parallelepiped shape, comprising a base ‘b’ and a height ‘a’, as shown in the figures.

According to one aspect of the invention, the system for adjusting the dimensions of said covering and protecting element 101, 201, 301, 401 comprises a plurality of side elements 104, 204, 304, 404, each placed over a corresponding side portion of the covering and protecting element 101, 201, 301, 401.

According to another aspect of the invention, according to three embodiments, shown respectively in FIGS. 1-4 and 6, the system for adjusting the dimensions of the aforementioned covering and protecting element 101, 201, 401 comprises a plurality of corner elements 103, 203, 403.

According to one aspect of the invention, in such three embodiments each corner elements 103, 203, 403 is slidingly placed in correspondence with a corresponding corner portion of the covering and protecting element 101, 201, 401.

In particular, for the first embodiment, the plurality of corner elements 103 comprises a pair of corner elements 103a, 103b positioned in correspondence with respective ends of side elements 104, which are fixed, and slide along an axis ‘x’ parallel to the base ‘b’ of the aforementioned covering and protecting element 101.

Furthermore, in this first embodiment there a further pair of corner elements 103c, 103d is provided, slidingly placed, respectively along an axis ‘z’ and an axis ‘k’, both oblique with respect to said base ‘b’ and height ‘a’, as visible in FIG. 1c.

Furthermore, according to one aspect of the invention, in the second embodiment each of the side elements 204 is slidingly placed along an axis ‘y’ parallel to the height ‘a’.

According to one aspect of the invention, in this second embodiment each of the corner elements 203 is placed in correspondence with a respective end of a corresponding side element 204, as well as able to slide along the ‘x’ axis, as shown in FIGS. 3 and 4.

According to another aspect of the invention, in an alternative embodiment, i.e., a third implementation variant visible in FIG. 5, the modular cover 300, in a simplified version compared to the previous two described, includes only the side elements 304, orthogonal to those shown in the FIGS. 1-4 for the two preferential 100 and 200 embodiments, able to slide, accordingly, along the ‘x’ axis.

According to one aspect of the invention, the external rear surface 101a, 201a, 301a, 401a is preferably flat.

According to another aspect of the invention, each of the corner elements 103, 203, 403 can also slide along an axis perpendicular to the external rear surface 101a, 201a, 401a.

According to one aspect of the invention, each of the side elements 104, 204, 304, 404 comprises a sliding arm and an interchangeable peripheral edge, the latter being removably connected to one end of the aforementioned sliding arm.

According to one aspect of the invention, each of the corner elements 103, 203, 403, referring respectively to the first, second and fourth embodiment, in turn includes a sliding arm and a related interchangeable peripheral edge removably connected to one end of the sliding arm.

In use, advantageously according to the invention, such a movement along an axis perpendicular to the external rear surface 101a, 201a, 401a of each of the corner elements 103, 203, 403 allows the depth of the covering end protecting element 101, 201, 401 to be adapted to the thickness of the specific electronic device 50, and is followed by the manual, telescopic adjustments of the corner and side elements, according to the different embodiments, which adapt the dimensions of the height ‘a’ and of the base ‘b’ of the same covering end protecting element 101, 201, 301, 401 to those of the electronic device 50.

According to one aspect of the invention, the covering end protecting element 101, 201, 301, 401 comprises, in correspondence with a front portion, opposite to the external rear surface 101a, 201a, 301a, 401a, an opening configured for a removable insertion of the electronic device 50 and to frame a display integrated into the electronic device 50.

According to one aspect of the invention, the at least one functional module consists of at least one subsystem comprised within the group consisting of:
a display 110, 210, 310, 410;
a power bank;
a camera;
a wireless speaker;
a solid state data storage drive;
an array of sensors;
a compass;
an altimeter.

According to one aspect of the invention, the covering and protecting element 101, 201, 301, 401 houses over its external rear surface 101a, 201a, 301a, 401a preferably several functional modules placed side by side, for example the display 110, 210, 310, 410 together with the power bank and the compass.

According to another aspect of the invention, several functional modules may be placed overlapped on each other.

According to one aspect of the invention, the at least one functional module, common to the four embodiments, is housed in its own container preferably made of plastic material.

According to one aspect of the invention, the at least one functional module comprises, as said, an electronic processing unit provided with at least one memory module and a control module saved to said memory module.

According to one aspect of the invention, for what concerns the at least one functional module implementing the display 110, 210, 310, 410, said display is connected to its electronic processing unit via a data transmission protocol compliant with the MIPI-DSI standard, a de facto standard for hardware and software interfaces in mobile devices, characterized by high energy efficiency, high quality in image and data transmission and high immunity to electromagnetic disturbances.

According to one aspect of the invention, the at least one functional module comprises electronic components and a rechargeable battery able to power said electronic components and the functional module itself.

According to one aspect of the invention, the control module comprised in the at least one functional module is implemented by means of a computer program product, managing the functional module itself, executed by the electronic processing unit.

According to one aspect of the invention, the functional module comprises, within the electronic components, a wireless data transmission module, preferably a Wi-Fi and/or Bluetooth LE microchip, connected to the electronic processing unit and configured for a data connection of the covering and protecting element 101, 201, 301, 401 with the electronic device 50 and/or with an external electronic device.

According to another aspect of the invention, the control module allows the electronic processing unit to manage also the operation of the wireless data transmission module, and the related wireless communications with the electronic device 50 and/or with an external electronic device, preferably to send static and dynamic images to the memory module, for example videos, to be reproduced by the display 110, 210, 310, 410.

In detail, according to the invention, such a control module is implemented, as said, by means of a computer program product executed by said electronic processing unit, which is preferably an MCU or an x86 or x64 CPU, in turn, as mentioned, equipped with at least one solid-state memory module, such as a flash memory module.

According to another aspect of the invention, the display 110, 210, 310, 410 is, preferably, an LCD/AMOLED display having approximate dimensions comprised between 3″ and 5″.

According to another aspect of the invention, the technical functions, implemented by the at least one functional module, may be alternatively managed by a further computer program product, i.e., an app, able to be downloaded from a dedicated store, installed on and executed by the electronic device 50.

According to another aspect of the invention, the technical functions, implemented by the at least one functional module, may be alternatively managed from the cloud.

According to another aspect of the invention, the at least one functional module is removably mounted on the external rear surface 101a, 201a, 301a, 401a of the covering and protecting element 101, 201, 301, 401 by means of an interlocking system.

According to one aspect of the invention, the modular cover 100, 200, 300, 400 comprises an interchangeable protective element 105, 205, 305, 405, or shell, able to be placed in correspondence with a portion of the external rear surface 101a, 201a, 301a, 401a of the covering and protecting element 101, 201, 301, 401, configured to frame a camera integrated in the electronic device 50.

According to another aspect of the invention, the interchangeable protective element 105, 205, 305, 405, able to protect the camera of the electronic device 50, also includes its own, further, interchangeable angular and side elements which adapt its profile, or curvature as far as concerns the concerning angular edges, to those of the camera of the electronic device 50.

According to another aspect of the invention, also the protecting and covering element 101, 201, 301, 401 may comprise, preferably placed in a dedicated internal housing, a further electronic processing unit, a memory module and a wireless data transmission module, as well as a further battery suitable for powering the aforementioned memory module, electronic processing unit and wireless data transmission module, the latter allowing the protecting and covering element 101, 201, 301, 401 to connect to the electronic device 50.

According to one aspect of the invention, the assembly comprising the covering and protecting element 101, 201, 301, 401, the display 110, 210, 310, 410, the corner elements 103, 203, 403, limited to such three embodiments, the side elements 104, 204, 304, 404 and the interchangeable protective element 105, 205, 305, 405 can be referred to as a universal, electronic and modular cover 100, 200, 300, 400, capable of personalizing the aesthetics, as well as protecting and expanding the functionalities, of the electronic device 50 enclosed in the modular cover itself.

According to another aspect Of the invention, the covering and protecting element 101, 201, 301, 401, alias the skeleton, has, as mentioned, a substantially parallelepiped shape and is preferably made of a plastic material.

According to one aspect of the invention, a Non-Fungible Token, or NFT, is able to be applied to the skeleton 101, 201, 301, 401.

According to one aspect of the invention, the skeleton 101, 201, 301, 401 has a thickness comprised between 4 millimeters and 8 millimeters.

Advantageously according to the invention, the interlocking system used for mounting the at least one functional module to the covering and protecting element 101, 201, 301, 401 allows the technical specifications of the individual electronic device 50 to be customized and extended easily, according to a plug & play mode.

Advantageously according to the invention, the wireless data transmission module comprised in the functional module, according to the display 110, 210, 310, 410 implementation, allows static images, videos and other static multimedia elements to be sent to the covering element 101, 201, 301, 401 and to be reproduced through the same display 110, 210, 310, 410.

Advantageously according to the invention, the telescopic type of the sliding arms included in the corner elements 103, 203, 403 and in the side elements 204, 304, 404 allows the dimensions of the covering and protecting element 101, 201, 301, 401 to be adapted to those of different models of electronic devices 50, ensuring the universality of the personalized modular cover 100, 200, 300, 400 that frames a specific smartphone, notebook or tablet, extending its native functionality.

Likewise, advantageously according to the invention, the interchangeability of each peripheral edge removably connected to a corresponding end of a sliding arm allows the native curvature of the corner edges of the electronic devices 50 to be traced, simply by replacing the aforementioned peripheral edges.

Advantageously according to the invention, the provision of a battery to each functional module allows the autonomy and useful life of the battery integrated in the electronic device 50 to be preserved.

According to another aspect of the invention, both the functional module and the protecting and covering element 101, 201, 301, 401 comprise a rechargeable battery.

Furthermore, according to the fourth embodiment shown in FIG. 6, which in fact combines technical characteristics of the embodiments 100 and 200, the covering element 401 includes the side elements 404 that may slide and differs in that it includes a first corner element 403a and a second corner element 403c.

According to one aspect of the invention, in this fourth embodiment the first corner element 403a is placed in correspondence with one end of a corresponding side element 404 sliding along the axis ‘y’ and is able to slide along the axis ‘x’.

According to one aspect of the invention, still regarding the embodiment 400, the second corner element 403c is placed slidingly along the axis ‘z’ which, as shown in FIG. 6, is oblique with respect to the base ‘b’ and the height ‘a’ of the covering and protecting element 401.

Therefore, the modular cover for electronic devices according to the invention allows to combine universality, modularity and advanced functionality, personalizing the aesthetics of the device to which it is applied thanks to static images and videos reproduced by a specific display, while protecting at the same time the structure of the device itself and extending the list of native £ technical characteristics thanks to one or more specific functional modules.

Another advantage of the modular cover for electronic devices according to the invention is that it is easy to use and requires low maintenance.

A further advantage of the modular cover for electronic devices according to the invention is that it is inexpensive.

Still, the modular cover for electronic devices according to the invention is easily scalable, both from a design and an industrial point of view thanks to its modular nature which allows the expansion and variation of its functionalities simply by changing functional blocks thanks to the interlocking system.

Finally, the modular cover for electronic devices according to the invention is characterized by a reduced complexity for what concerns a mass production.

It is finally clear that the modular cover for electronic devices, described and illustrated herein, may be subject to modifications and variations without departing from the protective scope of the present invention, as defined in the appended claims.

1-16. (canceled)

17. A modular cover for electronic devices, comprising:
a covering and protecting element having an external rear surface, removably housing an electronic device;
and a system for adjusting the dimensions of said covering and protecting element;
characterized in comprising at least one functional module, comprising an electronic processing unit, removably mounted on the external rear surface of the covering and protecting element, and in that the system for adjusting the dimensions of the covering and protecting element comprises a plurality of sliding arms and a plurality of interchangeable peripheral edges, each interchangeable peripheral edge being removably connected to one end of a corresponding sliding arm.

18. The modular cover according to claim 17, wherein said covering and protecting element has a substantially parallelepiped shape comprising a base ‘b’ and a height ‘a’, and in that the system for adjusting the dimensions of said covering and protecting element comprises a plurality of side elements, each placed over a corresponding side portion of the covering and protecting element.

19. The modular cover according to claim 18, wherein each of the side elements comprises a sliding arm and a corresponding interchangeable peripheral edge removably connected to one end of said sliding arm.

20. The modular cover according to claim 17, wherein the system for adjusting the dimensions of said covering and protecting element comprises a plurality of corner elements, each of said corner element being slidingly placed in correspondence with a corresponding corner portion of the covering and protecting element, in that the external rear surface is flat, and in that each of the corner elements comprised in the plurality of corner elements is able to slide along an axis perpendicular to said external rear surface.

21. The modular cover according to claim 20, wherein the plurality of corner elements comprises a couple of corner elements slidingly placed, in correspondence with corresponding ends of side elements, along an axis ‘x’ parallel to the base ‘b’ of said covering and protecting element, and a couple of corner elements slidingly placed, respectively along an axis ‘z’ and an axis ‘k’ oblique to said base ‘b’ and height ‘a’.

22. The modular cover according to claim 20, wherein each of said side elements is slidingly placed, along an axis ‘y’ parallel to said height ‘a’, and in that each of said corner elements is placed in correspondence with a respective end of a corresponding side element, able to slide along the axis ‘x’.

23. The modular cover according to claim 18, wherein each of the side elements is slidingly placed along the axis ‘x’.

24. The modular cover according to claim 20, wherein the plurality of corner elements comprises a first corner element positioned in correspondence with an end of a corresponding side element slidable along the axis ‘y’, said first corner element being slidable along the axis ‘x’, and a second corner element placed slidingly along the axis ‘z’ oblique with respect to said base ‘b’ and height ‘a’.

25. The modular cover according to claim 20, wherein each of the corner elements comprises a sliding arm and a corresponding interchangeable peripheral edge removably connected to one end of said sliding arm.

26. The modular cover according to claim 17, wherein the covering and protecting element comprises, in correspondence with a front portion, opposite to the external rear surface, an opening configured for a removable insertion of the electronic device and to frame a display integrated in said electronic device.

27. The modular cover according to claim 17, wherein the at least one functional module consists of at least one subsystem comprised within the group consisting of:
a display;
a battery;
a camera;
a wireless speaker;
a solid state data storage drive;
an array of sensors;
a compass; and
an altimeter.

28. The modular cover according to claim 17, wherein the electronic processing unit, comprised in the at least one functional module, is provided with at least one memory module and a control module, saved to said at least one memory module, managing the at least one functional module and implemented by a computer program product executed by said electronic processing unit.

29. The modular cover according to claim 17, wherein said at least one functional module comprises a rechargeable battery able to power said at least one functional module.

30. The modular cover according to claim 17, wherein the at least one functional module is removably mounted on the external rear surface by an interlocking system.

31. Modular cover according to claim 17, wherein the at least one functional module comprises a wireless data transmission module, connected to the electronic processing unit, configured for the connection of said at least one functional module with the electronic device, said electronic device being comprised within the group consisting of:
smartphone;
tablet;
notebook; and
a case of a desktop PC.

32. Modular cover according to claim 17, wherein said modular cover comprises an interchangeable protective element, placed in correspondence with one portion of the external rear, configured to frame a camera integrated in the electronic device.
